(19) United States
(12) Patent Application Publication
(10) Pub. No.: US 2026/0197086 A1
(43) Pub. Date: Jul. 9, 2026

(54) OPTICAL TRANSMITTER, OPTICAL RECEIVER AND OPTICAL TRANSCEIVER CHIP

(71) Applicant: SILITH TECHNOLOGY PTE. LTD., SINGAPORE (SG)

(72) Inventors: Xingyu ZHANG, Shanghai (CN); Ke ZHANG, Shanghai (CN)

(73) Assignee: SILITH TECHNOLOGY PTE. LTD., SINGAPORE (SG)

(21) Appl. No.: 19/550,224

(22) Filed: Feb. 25, 2026

Related U.S. Application Data
(63) Continuation of application No. PCT/CN2023/115527, filed on Aug. 29, 2023.

(51) Int. Cl. H04B 10/40; H04B 10/50; H04B 10/67; H04J 14/02

(52) U.S. Cl. CPC H04B 10/40; H04B 10/506; H04B 10/671; H04J 14/0307

(57) ABSTRACT

Optical transmitter comprises: N light sources with different wavelengths; m levels of beam splitting section comprising m levels of beam splitter section and m levels of waveguide crossing section, each level waveguide crossing section comprises N×2^{m} channels; first level beam splitter section divides optical signals from N light sources into a 2N-channel output signal; k+1-th level beam splitter section divides an N×2^{k}-channel output signals from k-th level beam splitter section into an N×2^{k+1}-channel output signal, an output signal of each channel has one output power; N×2^{m} function blocks and 2^{m} multiplexers, N×2^{m}-channel output signal produced by m-th level beam splitting section connect to m levels of waveguide crossing section and then function blocks and multiplexers sequentially, each multiplexer combines N-channel output signal with different wavelengths. Achieved signal transmission in multi-channel, multi-wavelength, having flexible extension.

### CROSS-REFERENCE TO RELATED APPLICATION

This application is a continuation of international PCT application No. PCT/CN2023/115527, filed on Aug. 29, 2023. The entirety of the above-mentioned patent application is hereby incorporated by reference herein and made a part of this specification.

### BACKGROUND

### Technical Field

The present disclosure relates to the technical field of optical chips, and in particular to an optical transmitter, an optical receiver and an optical transceiver chip.

### Description of Related Art

Wavelength division multiplexing (WDM) has been widely applied in a plurality of technical fields including optical communications, optical interconnections and more. In an embodiment, FIG. 1 shows a schematic diagram on an architecture of an application of a conventional FR4 transmitter (or called CWDM4), comprising four light sources with different wavelengths; a plurality of function blocks applied for signal modulation, signal processing, signal control, and more; and a multiplexer (MUX) configured to merge four wavelengths into one channel. The architecture shown in FIG. 1 can be applied to an assembly composed by packaging a plurality of discrete components, or applied to an optical chip having all components integrated, or further applied to a combination of a plurality of discrete components and an optical chip having a part of all components integrated. Specifically, in an application of a 100 G CWDM 4 transmitter, each wavelength corresponds to one channel, and each channel carries a 25 G NRZ modulation signal respectively, thus four channels will achieve a 4×25 G=100 G signal transmission. In an application of 400 G FR4 , each wavelength corresponds to one channel, and each channel carries a 100 G PAM4 modulation signal respectively, thus four channels will achieve a 4×100 G=400 G signal transmission.

An architecture of a 2×FR4 transmitter applied to a new generation of 800 G application is shown as FIG. 2. Each of four wavelengths is divided into two beams through a 1×2 (50/50 ) beam splitter respectively, and combined by two multiplexers after passing through a waveguide crossing section (shown as a dash box area in FIG. 2), and finally achieving two assemblies of FR4, thus it is called 2×FR4. So each wavelength corresponds to two channels, and totally eight channels; each channel carries a 100 G PAM4 modulation signal respectively, thus eight channels will achieve a 8×100 G=800 G signal transmission. In the optical chip, both the beam splitter and the waveguide crossing can be achieved through an optical waveguide, being integrated inside the optical chip together with a plurality of other components. For a next-generation application of wavelength-division multiplexing having a higher transmission rate, such as an application of 1.6 T, 3.2 T and above, there is an urgent demand for a new architecture, which is able to achieve a multi-channel and multi-wavelength signal transmission. While more channels (or wavelengths), more complicated the architecture of a whole wavelength division multiplexing system is, especially more complicated waveguide crossings (in the optical chip, it is the waveguide crossing) have to be used, which causes a design of the architecture more difficult. Therefore, providing a new architecture of wavelength division multiplexing is needed urgently, so as to address a problem in the prior art as described above.

### SUMMARY

An objective of the present disclosure is to provide an optical transmitter, an optical receiver and an optical transceiver chip, performing an effective extension on an architecture in the prior art, to achieve a multi-channel and multi-wavelength signal transmission, having a design of the architecture simplified and a flexible scalability.

In a first aspect, the present disclosure provides an optical transmitter, comprising N light sources with different wavelengths, m levels of beam splitting section, a plurality of function blocks in a number of N×2^{m}, and a plurality of multiplexers in a number of 2^{m}. The m levels of beam splitting section comprise m levels of beam splitter section and m levels of waveguide crossing section. Each level of the waveguide crossing section comprises N×2^{m} channels. A first level beam splitter section divides a plurality of optical signals coming from the N light sources with different wavelengths into a 2N-channel output signal. A k+1-th level beam splitter section divides an N×2^{k}-channel output signal coming from a k-th level beam splitter section into an N×2^{k+1}-channel output signal. An output signal of each channel has one output power. An N×2^{m}-channel output signal having been split and generated by an m-th level beam splitting section, is transmitted to m levels of waveguide crossing section, then to the function blocks and the multiplexers sequentially. Each multiplexer is configured to combine N output signals with different wavelengths coming from N channels. In a second aspect, the present disclosure provides an optical transmitter,

comprising a plurality of light sources in a number of L×n, m levels of beam splitting section, a plurality of function blocks in a number of L×n×2^{m} and a plurality of multiplexers in a number of L×2^{m}. The plurality of light sources comprise n light sources with different wavelengths, and each light source with a wavelength has a number of L, while both L and n are positive integers. The m levels of beam splitting section comprise m levels of beam splitter section and m levels of waveguide crossing section. Each level of the waveguide crossing section comprises a plurality of channels in a number of L×n×2^{m}. A k-th level beam splitter section comprises a plurality of beam splitters in a number of L×n×2^{k-1}, wherein m is a positive integer, and k has a value range of 1 to m. The m levels of beam splitting section are able to be scaled as needed. A first level beam splitter section divides an optical signal coming from the light sources in the number of L×n into an L×n×2¹-channel output signal. A k+1-th level beam splitter section divides an L×n×2^{k}-channel output signal coming from a k-th level beam splitter section into an L×n×2^{k+1}-channel output signal. An output signal of each channel has one output power. A 2^{m}-channel output signal being split and generated by an m-th level beam splitting section, is transmitted to the m levels of waveguide crossing section, the function blocks and the multiplexers sequentially. Each multiplexer is configured to combine n output signals with different wavelengths coming from n channels.

In a third aspect, the present disclosure provides an optical transmitter, comprising N light sources with different wavelengths, m levels of beam splitting section, a plurality of function blocks in a number of N×2^{m} and a plurality of multiplexers in a number of 2^{m}. The m levels of beam splitting section comprise m levels of beam splitter section and at least one level waveguide crossing section. Each level of the waveguide crossing section comprises N×2^{m} channels. A k-th level beam splitter section comprises a plurality of beam splitters in a number of N×2^{k-1}, both N and m are positive integers greater than 1, k has value range from 1 to m. The m levels of beam splitting section can be scaled as needed. A first level beam splitter section divides an optical signal coming from the N light sources with different wavelengths into an N×2¹-channel output signal. A k+1-th level beam splitter section divides an N×2^{k}-channel output signal coming from a k-th level beam splitter section into an N×2^{k+1}-channel output signal. An output signal of each channel has one output power. An N×2^{m}-channel output signal being split and generated by an m-th level beam splitting section are transmitted to the at least one level waveguide crossing section, the function blocks and the multiplexer in a sequence. Each multiplexer is configured to combine N output signals with different wavelengths coming from N channels.

In a preferred embodiment, the beam splitter comprises at least one of a Y-shaped branch, a trident-shaped branch, a multi-mode interferometer, a directional coupler, an adiabatic coupler, a bent coupler, a photonic crystal beam splitter, and a sub-wavelength beam splitter.

In another preferred embodiment, the multiplexer comprises at least one of an arrayed waveguide grating, an Echelle grating, a plurality of Mach-Zehnder interferometers in a cascade, a plurality of microrings in a cascade, a plurality of Mach-Zehnder interferometers and microrings in a cascade, and a plurality of Fabry Perot interferometers.

In another preferred embodiment, a type of a waveguide in the beam splitter, the waveguide crossing, the multiplexer, a demultiplexer and the function blocks comprises a channel waveguide, a ridge waveguide, a slot waveguide, a diffusion waveguide, and a photonic crystal waveguide.

In another preferred embodiment, the light source may comprise at least one of an external light source, an on-chip hybrid integrated or heterojunction integrated light source; an integrated material comprises at least one of an III-V/silicon light source, an III-V/silicon nitride light source, and an III-V/thin film lithium niobate.

In a fourth aspect, the present disclosure provides an optical receiver, comprising: a plurality of demultiplexers in a number of M, a photodetector and at least one level waveguide crossing section;
the demultiplexers correspond and connect to the multiplexers of the optical transmitter one by one; the demultiplexer is configured to demultiplex the output signal coming from the multiplexer, to obtain an N-channel output signal with different wavelengths; at least one level waveguide crossing section, configured to transmit an N×M-channel output signal demultiplexed and generated by the M demultiplexers to a plurality of photodetectors in a number of N×M; the photodetectors are corresponding to the channels of the optical receiver one by one.

In one preferred embodiment, the demultiplexer comprises at least one of an arrayed waveguide grating, an Echelle grating, a plurality of Mach-Zender interferometers in a cascade, a plurality of microrings in a cascade, a plurality of Mach-Zended interferometers and microrings in a cascade, and a Fabry Perot interferometer.

In a fifth aspect, the present disclosure provides an optical transceiver chip, comprising an optical receiver and the optical transmitter according to anyone in the first aspect; the optical receiver comprises a demultiplexer, a photodetector and at least one level waveguide crossing section; a number of the demultiplexer is as same as a number of the multiplexer, the demultiplexer is configured to demultiplex an output signal coming from the multiplexer, obtaining an N-channel output signal with different wavelengths; at least one level waveguide crossing section, a number of the channels comprised by each level waveguide crossing section is as same as a number of the channels of the optical transmitter; the at least one level waveguide crossing section is configured to transmit the N×2^{m}-channel output signal demultiplexed and generated by the 2^{m} demultiplexer to the photodetector; each channel of the photodetector corresponds to a channel of the optical receiver, having a same number.

In one preferred embodiment, an integrated material platform where an architecture of the optical transceiver chip is located comprises at least one of Bulk Silicon, Silicon-On-Insulator, Silicon-On-Sapphire, Silicon Dioxide, Aluminum Oxide, Indium Phosphide, Lithium Niobate, Barium Titanate and a polymer thereof.

In another preferred embodiment, a waveguide type of a beam splitter of the optical transmitter and the waveguide crossing comprises a channel waveguide, a ridge waveguide, a slot waveguide, a diffusion waveguide and a photonic crystal waveguide; the demultiplexer comprises at least one of an array waveguide grating, an Echelle grating, a plurality of Mach-Zender interferometers in a cascade, a plurality of microrings in a cascade, a plurality of Mach-Zended interferometers and microrings in a cascade, and a Fabry Perot interferometer.

In another preferred embodiment, a wavelength range of the wavelengths comprises a visible optical band, an O-band, an E-band, an S-band, a C-band, an L-band, a U-band and a mid-infrared band.

In another preferred embodiment, a realization method of the waveguide crossing section comprises at least one of a multi-mode waveguide crossing, a non-linear-shape optimized crossing, a multi-layer waveguide crossing and a multi-material-layer waveguide crossing.

In another preferred embodiment, the optical transmitter is applied to an assembly composed by packaging several discrete components, or an optical chip having all components integrated, or a combination of several discrete components and an optical chip having a part of all components integrated.

A beneficial effect of the optical transmitter, the optical receiver and the optical transceiver chip provided by the present disclosure is: by performing an effective scaling to a 2×FR4 architecture in the prior art, it is able to achieve a multi-channel and multi-wavelength signal transmission, having a design of the architecture simplified and a flexible scalability.

### BRIEF DESCRIPTION OF THE DRAWINGS

FIG. 1 illustrates a schematic structural diagram on an FR4 (or called CWDM4) transmitter application applied in a traditional 400 G application.

FIG. 2 illustrates a schematic structural diagram on a 2×FR4 transmitter applied in a new generation 800 G application.

FIG. 3 illustrates a schematic structural diagram on a 4×FR4 transmitter provided by an embodiment of the present disclosure.

FIG. 4 illustrates a schematic structural diagram on an 8×FR4 transmitter provided by an embodiment of the present disclosure.

FIG. 5 illustrates a schematic structural diagram on another 8×FR4 transmitter provided by an embodiment of the present disclosure.

FIG. 6 illustrates a schematic structural diagram on a 2×FR8 transmitter provided by an embodiment of the present disclosure.

FIG. 7 illustrates a schematic structural diagram on a 2×FR8 transmitter comprising two levels waveguide crossing section provided by an embodiment of the present disclosure.

FIG. 8 illustrates a schematic structural diagram on a 2×FR8 transmitter comprising one level waveguide crossing section provided by an embodiment of the present disclosure.

FIG. 9 illustrates a schematic structural diagram on a 4×FR8 transmitter provided by an embodiment of the present disclosure.

FIG. 10 illustrates a schematic structural diagram on a 4×FR4 receiver provided by an embodiment of the present disclosure.

FIG. 11 illustrates a schematic structural diagram on an optical transceiver chip having a 4×FR4 transmitter and receiver provided by an embodiment of the present disclosure.

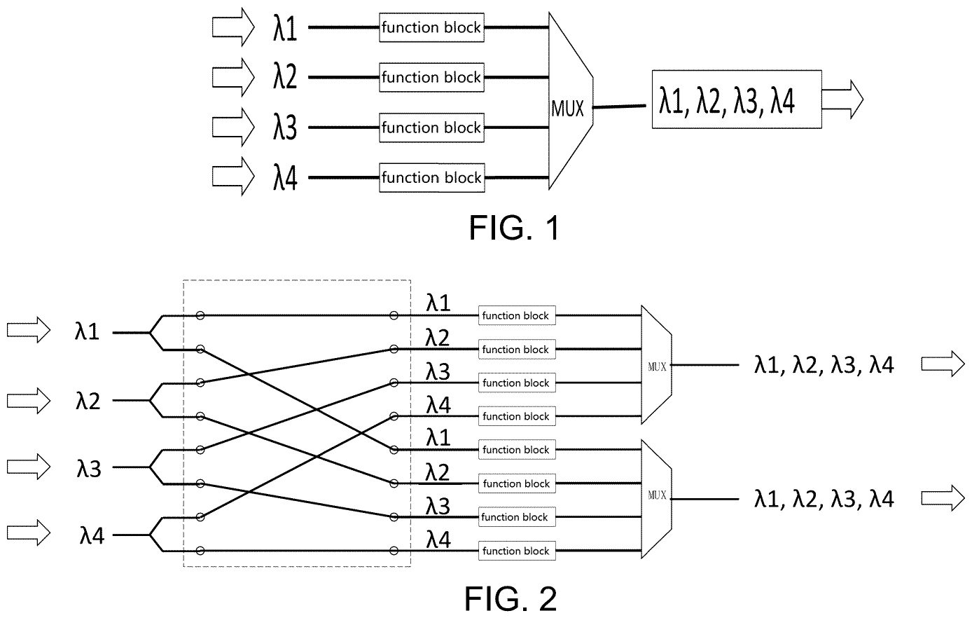

### DESCRIPTION OF THE EMBODIMENTS

In order to make the objective, technical solution and advantages of the present disclosure clearer, the technical solutions in the embodiments of the present disclosure will be clearly and completely described below in conjunction with the drawings of the present disclosure. Obviously, the described embodiments are part of, but not all of, the embodiments of the present disclosure. Based on the embodiments of the present disclosure, all other embodiments obtained by those of ordinary skill in the art without creative work are included in the protection scope of the present disclosure. Unless otherwise defined, technical or scientific terms used herein should have the meanings usually understood by those of ordinary skill in the field to which the present disclosure belongs. As used herein, the terms “comprise” and the like are intended to mean that an element or item appearing before the term encompasses elements or items appearing after the term and their equivalents, but does not exclude other elements or items.

Aiming at the problems existed in the prior art, an embodiment of the present disclosure provides an optical transmitter, comprising N light sources with different wavelengths, m levels of beam splitting section, a plurality of function blocks in a number of N×2^{m} and a plurality of multiplexers in a number of 2^{m}. The m levels of the beam splitting section comprise m levels of beam splitter section and m levels of waveguide crossing section. Each level of the waveguide crossing section comprises N×2^{m} channels. A first level beam splitter section divides an optical signal from the N light sources with different wavelengths into a 2N-channel output signal. A k+1-th level beam splitter section divides an N×2^{k}-channel output signal from a k-th level beam splitter section into an N×2^{k+1}-channel output signal. An output signal of each channel has one output power. An N×2^{m}-channel output signal which is split and produced by an m-th level beam splitting section is transmitted to m levels of waveguide crossing section and then the function blocks and the multiplexers sequentially. Each multiplexer is configured to combine N output signals with different wavelengths coming from N channels.

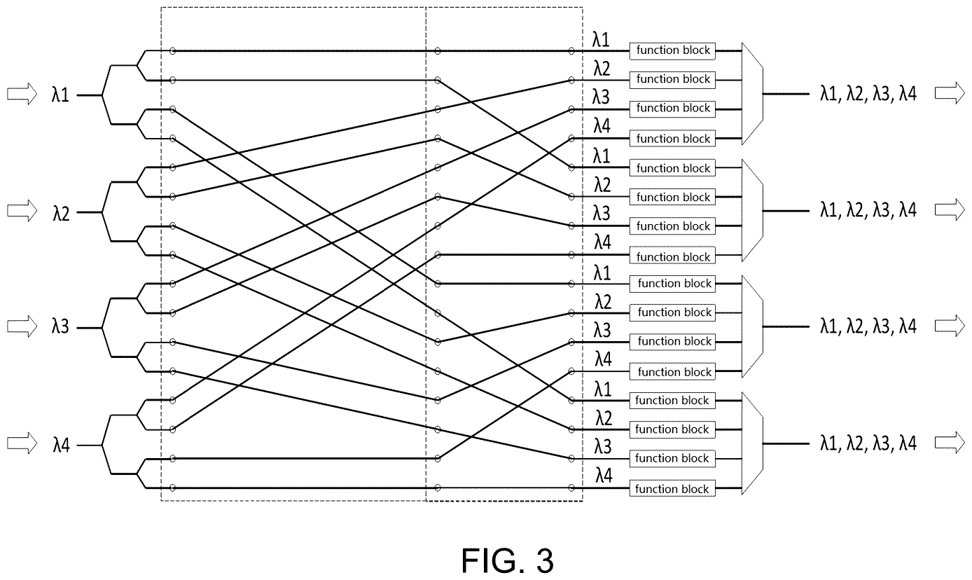

In an embodiment, as shown in FIG. 3, the present embodiment provides a 4×FR4 transmitter architecture. On a basis of two parallel architectures of a 2×FR4 transmitter shown in FIG. 2, one more cascaded 50/50 beam splitter and a new level waveguide crossing section is added in, totally there are two levels of waveguide crossing section (shown as a dashed block diagram area). In such a way, an original architecture of the 2×FR4 transmitter keeps unchanged, and just by adding additionally a beam splitter and a waveguide crossing section, the number of the channels can be expand effectively, so as to achieve a 1.6 T signal transmission rapidly.

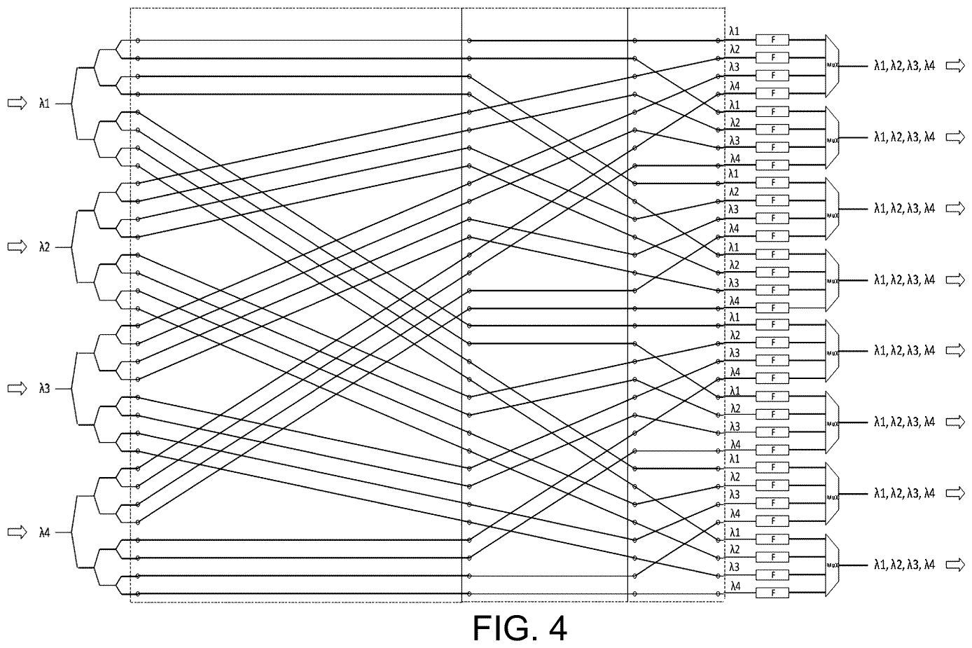

It should be noted that, a further upward scaling based on the architecture shown in FIG. 3 can be further continued. In an embodiment, as shown in FIG. 4, on a basis of two parallel architectures of the 4×FR4 transmitter, by adding one more cascaded 50/50 beam splitter and a new level waveguide crossing section, totally three levels of the waveguide crossing section (shown as a dashed block diagram area), a number of the channels can be doubled to achieve an architecture of an 8×FR4 transmitter, that is, achieving a 3.2 T signal transmission. Similarly, it can be further expanded upward on a basis of an architecture shown in FIG. 4, for example, realizing an architecture of a 16×FR4 transmitter (a 6.4 T signal transmission), an architecture of a 32×FR4 transmitter (a 12.8 T signal transmission), and more.

It should be noted that, during a process of a multi-channel scaling, a light emitted from each light source with a certain wavelength shall be divided for multiple times, thus an intensity of a light entering each channel will be weaken, resulting in an intensity of a final output light not being able to meet a system requirement. In order to address such a problem, the present embodiment designs more than one light sources with each wavelength. Accordingly, a number of the cascaded beam splitter can also be adjusted effectively. Therefore, an embodiment of the present disclosure further provides an optical transmitter, comprising: a plurality of light sources in a number of L×n, including n light sources with different wavelengths, and a number of the light sources with each wavelength is L, both L and n are positive integers; m levels of beam splitting section, comprising m levels of beam splitter section and m levels of waveguide crossing section.
wherein each level of the waveguide crossing section comprises a plurality of channels in a number of L×n×2^{m}, a k-th level beam splitter section comprises a plurality of beam splitters in a number of L×n×2^{k-1}, m is a positive integer, and a value range of k is from 1 to m, the m levels of beam splitting section are able to be expanded as needed; a first level beam splitter section divides an optical signal from the light sources in the number of L×n into an L×n×2¹-channel output signal, a k+1-th level beam splitter section divides an L×n×2^{k}-channel output signal coming from a k-th level beam splitter section into an L×n×2^{k+1}-channel output signal, an output signal of each channel has one output power;

The optical transmitter further comprises a plurality of function blocks in a number of L×n×2^{m} and a plurality of multiplexers in a number of L×2^{m}, wherein a 2^{m}-channel output signal split and generated by an m-th level beam splitting section connect to m levels of waveguide crossing section and then the function blocks and the multiplexers sequentially, while each multiplexer is configured to combine n output signals with different wavelengths coming from n channels.

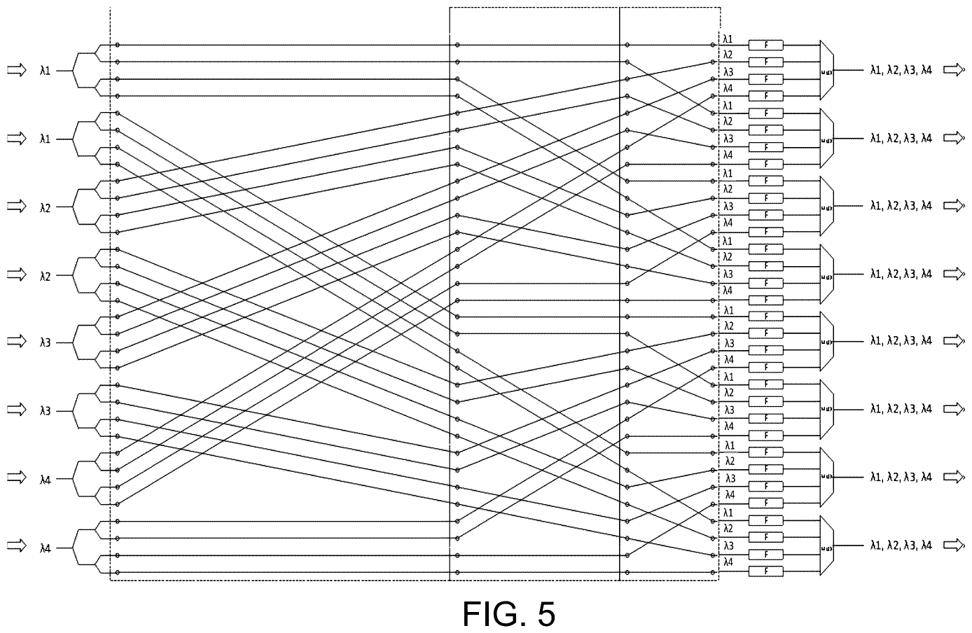

In an embodiment, FIG. 5 illustrates another architecture of an 8×FR4 transmitter, wherein each wavelength may be provided by two light sources, an according beam splitter is adjusted into two levels cascade, thus an optical intensity in each channel will be doubled. Similarly, in the architecture of the 8×FR4 transmitter, each wavelength can also be provided by four light sources, accordingly, the beam splitter is adjusted into one level cascade (not showed in the figures). In addition, similarly, in the architecture of the 4×FR4 transmitter as shown in FIG. 3, it is also possible to change each wavelength into being provided by two light sources, and an according beam splitter is adjusted into one level cascade (not showed in the figures).

It can be seen that the embodiments stated above is expanding a number of the channels by cascading a plurality of beam splitters (that is, increasing a number of the beam after being split), while keeping a number of the wavelengths unchanged. In another embodiment of the present disclosure, it is also possible to expand the number of the channels by increasing a number of the wavelengths while keeping the beam splitters same. That is, the present disclosure further provides an optical transmitter, comprising: N light sources with different wavelength and m levels of beam splitting section. The m levels of beam splitting section comprise m levels of beam splitter section and m levels of waveguide crossing section. Wherein each level of waveguide crossing section comprises a plurality of channels in a number of N×2^{m}. A k-th level beam splitter section comprises a plurality of beam splitters in a number of N×2^{k-1}. Both N and m are positive integers greater than 1, and a value range of k is from 1 to m. The m levels of beam splitting section can be expanded as needed. The first level beam splitter section divides the optical signal from the light sources with N different wavelengths into a 2N-channel output signal. A k+1-th level beam splitter section divides an N×2^{k}-channel output signal from the k-th level beam splitter section into an N×2^{k+1}-channel output signal. An output signal of each channel has one output power.

The optical transmitter further comprises a plurality of function blocks in a number of N×2^{m} and a plurality of multiplexers in a number of 2^{m}, wherein an N×2^{m}-channel output signal being split and generated by an m-th level beam splitting section, connects to the at least one level of waveguide crossing section and then the function blocks and the multiplexers sequentially, while each multiplexer is configured to combine N output signals with different wavelengths coming from N channels.

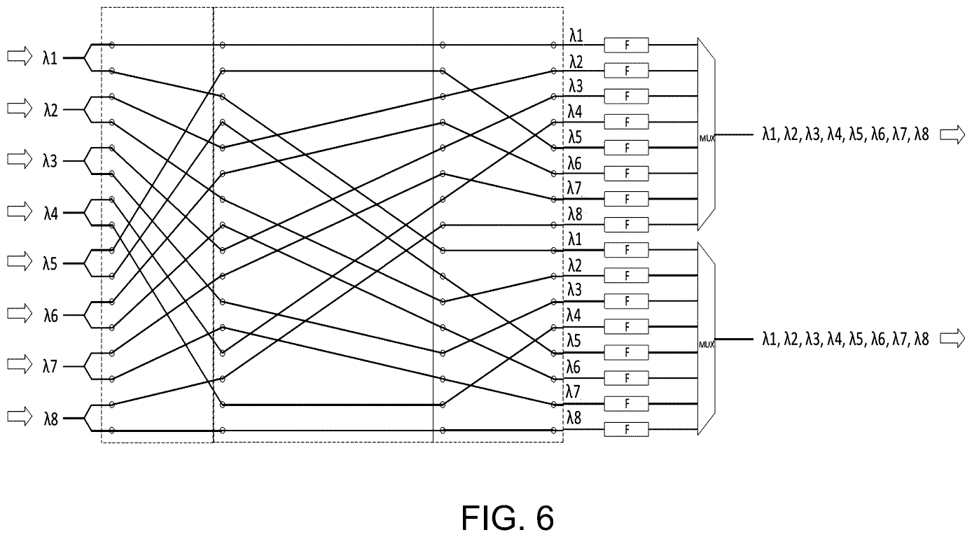

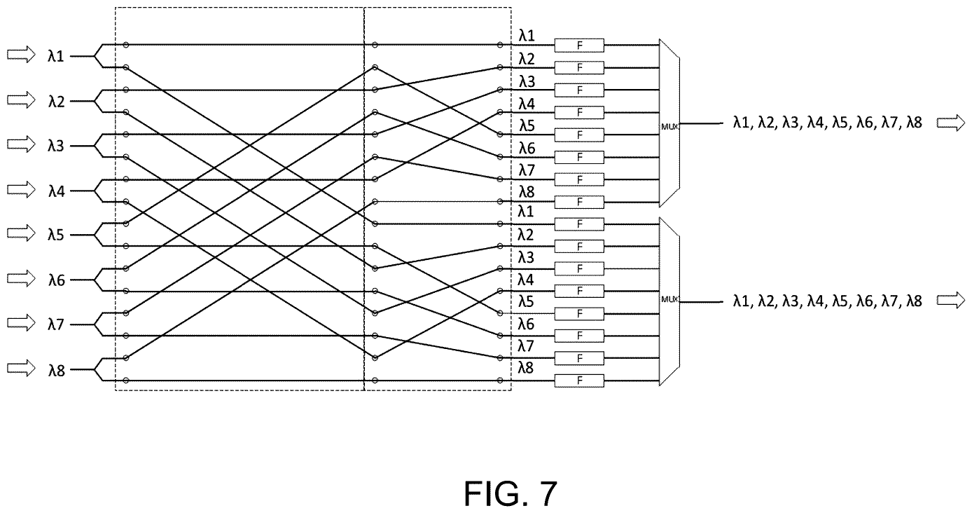

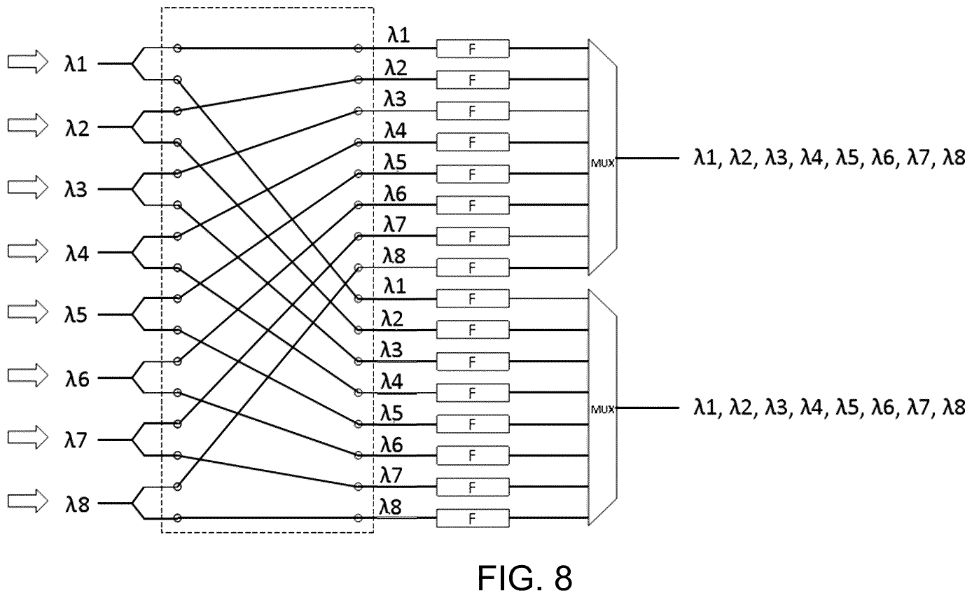

In an embodiment, FIG. 6 illustrates an architecture of a 2×FR8 transmitter, achieving a 1.6 T signal transmission. The present architecture is adjusted on a basis of the 4×FR4 showed in FIG. 3, wherein a number of the light sources is 8, the cascaded beam splitter is also reduced by one level accordingly, and a new set of waveguide crossing section is added. In addition, the multiplexer is changed to combine an output signal with 8 different wavelengths coming from 8 channels. In such a way, only a part of an architecture of the 4×FR4 transmitter shall be changed to realize quickly the architecture of the 2×FR8 transmitter, which is convenient and flexible. It is noted that, in the architecture of the 2×FR8 transmitter shown in FIG. 6, a waveguide crossing can be further adjusted and modified according to a specific requirement, such as reducing a number of the cascade of the waveguide crossing as needed. As shown in FIG. 7, the optical transmitter comprises two levels of the waveguide crossing section. Or shown as FIG. 8, the optical transmitter comprises one level of the waveguide crossing section.

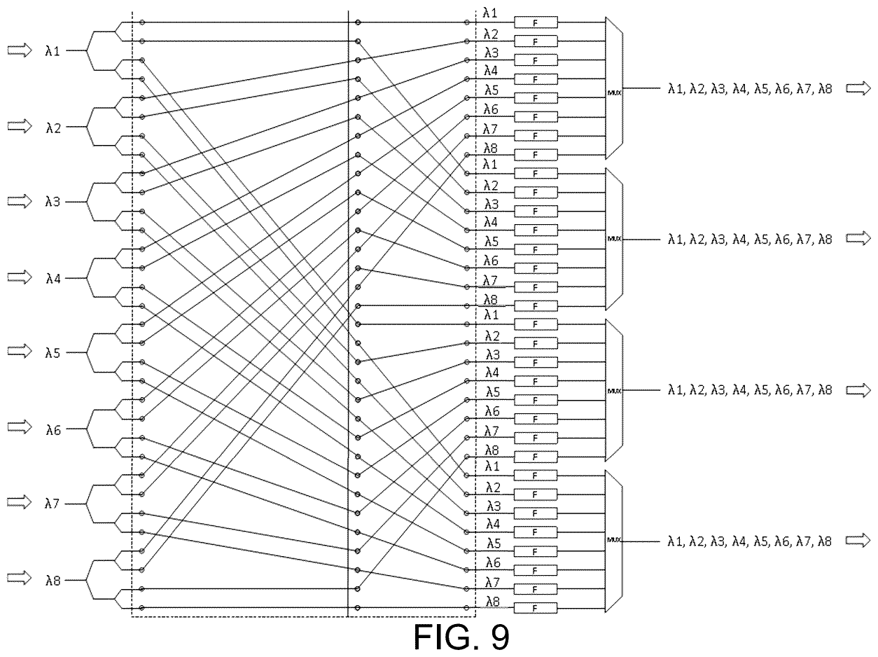

The embodiments stated above discuss to expand the number of channels through either cascading the beam splitters while maintaining a same number of the wavelength, or increasing a number of the wavelengths while maintaining a same number of the beam splitters, respectively. In addition, both the number of the cascaded beam splitters and the number of the wavelengths can be increased simultaneously, in order to achieve an scaling of the number of the channels. FIG. 9 illustrates an architecture of a 4×FR8 transmitter, that is, on a basis of two parallel architectures of the 2×FR8 transmitter showed in FIG. 8, one more cascaded beam splitter and an additional level waveguide crossing section is added, totally two levels of the waveguide crossing section (shown as the dashed block diagram area), it is able to expand quickly a number of the channels, and realize a 3.2 T signal transmission, being convenient and flexible.

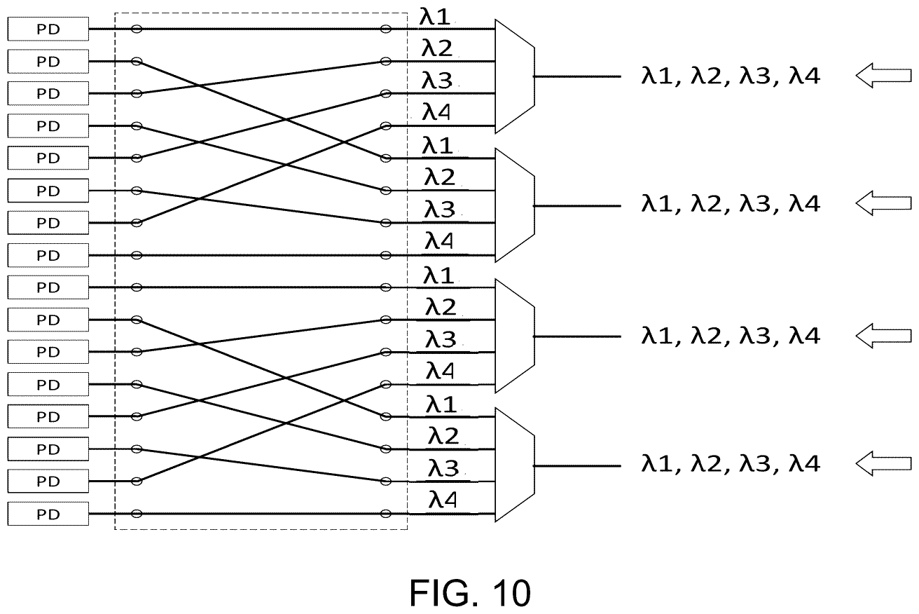

An embodiment of the present disclosure further provides an optical receiver, comprising: M demultiplexers, a photodetector and at least one level waveguide crossing section; the demultiplexers correspond and connect to the multiplexers of the optical transmitter one by one; the demultiplexer is configured to demultiplex the output signal coming from the multiplexer, before obtaining the N-channel output signal with different wavelengths; at least one level waveguide crossing section, configured to transmit the output signals of N×M channels demultiplexed and generated by the M demultiplexers to a plurality of photodetectors in a number of N×M; the photodetectors are corresponding to the channels of the optical receiver one by one. In an embodiment, FIG. 10 illustrates a 4×FR4 receiver, comprising 4 demultiplexers, one level waveguide crossing section and a photodetector (PD), which is able to achieve receiving a 1.6 T signal. The demultiplexer corresponds and connects to the multiplexers of the optical transmitter one by one. The demultiplexer is configured to demultiplex the output signal coming from the multiplexer before obtaining the output signals with different wavelengths of 4 channels. The one level waveguide crossing section is configured to transmit the output signals of 16 channels demultiplexed and generated by 4 demultiplexers to 16 photodetectors. The channels of the photodetector and the optical receiver are corresponding to each other one by one.

The present disclosure further provides an optical transceiver chip, comprising an optical receiver and the optical transmitter stated in anyone embodiment above; the optical receiver comprises a demultiplexer, a photodetector and at least one level waveguide crossing section. A number of the demultiplexer is as same as a number of the multiplexer. And the demultiplexer is configured to demultiplex an output signal coming from the multiplexer, and obtain the N-channel output signal with different wavelengths; The at least one level waveguide crossing section, wherein a number of the channels comprised by each level waveguide crossing section is as same as a number of the channels of the optical transmitter. The at least one level waveguide crossing section is configured to transmit the output signal of N×2^{m} channels demultiplexed and generated by the 2^{m} demultiplexer to the photodetector; a channel of the photodetector and a channel of the optical receiver is corresponding one by one, having a same number.

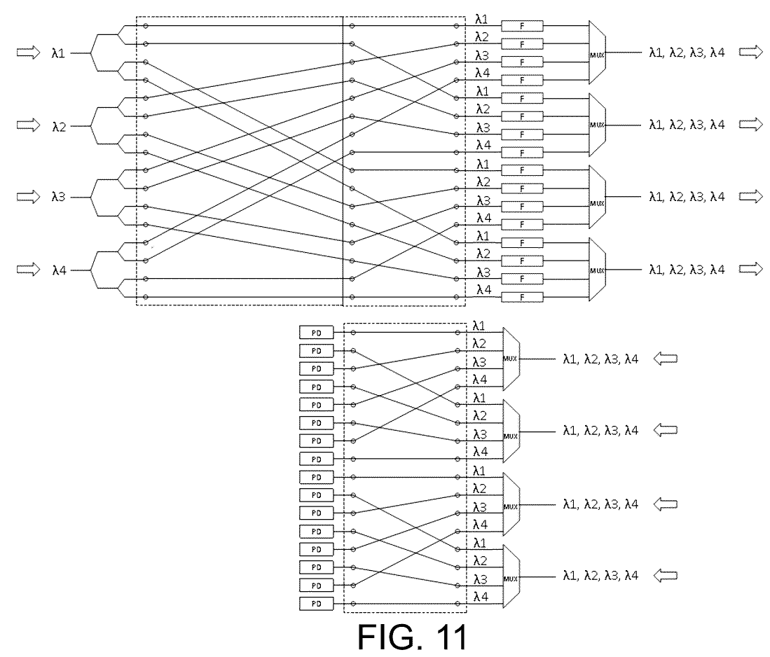

In an embodiment, FIG. 11 illustrates an integrated architecture of a 4×FR4 transmitter and a receiver. That is, both the transmitter and the receiver are integrated in a same chip. Four light sources in the optical transmitter send out four optical beams with different wavelengths individually, two levels of beam splitting section comprise two levels of beam splitter section and two levels of waveguide crossing section, wherein, each waveguide crossing section comprises 16 channels. A first level beam splitter section comprises 4 beam splitters, a second level beam splitter section comprises 8 beam splitters; the first level beam splitter section divides a plurality of optical signals coming from four light sources with different wavelengths into an 8-channel output signal; the second level beam splitter section divides the 8-channel output signal coming from the first level beam splitter section into a 16-channel output signal, and an output signal of each channel has one output power; 16 function blocks and 16 multiplexers, wherein the 16-channel output signal—produced by a second level beam splitting section, are transmitted to a second level waveguide crossing section and then the function blocks and the multiplexers sequentially, while each multiplexer is configured to combine 4 output signals with different wavelengths coming from 4 channels. A number of the demultiplexer in the optical receiver is as same as a number of the multiplexer. The demultiplexer is configured to demultiplex an output signal from the multiplexer before obtaining an output signal with different wavelengths in 4 channels; a number of the channels comprised by a first level waveguide crossing section is as same as a number of the channels in the optical transmitters, being also 16 channels; the first level waveguide crossing section is configured to transmit the output signals of 16 channels demultiplexed and generated by the 4 demultiplexers to a photodetector. A channel in the photodetector is corresponding to a channel in the optical receiver one by one, having a same number.

It is noted that, the architecture stated above can be applied to an assembly composed by packaging several discrete components, or an optical chip having all components integrated, or a combination of several discrete components and an optical chip having a part of all components integrated. Aiming to an integrated optical chip, an integrated material platform where the architecture locates comprises at least one of Bulk Silicon, Silicon-On-Insulator, Silicon-On-Sapphire, Silicon Dioxide, Aluminum Oxide, Indium Phosphide, Lithium Niobate, Barium Titanate and a polymer thereof.

In another preferred embodiment, the beam splitter comprises but not limited to at least one of a Y-shaped branch, a trident-shaped branch, a multi-mode interferometer, a directional coupler, an adiabatic coupler, a bending coupler, a photonic crystal beam splitter, and a sub-wavelength beam splitter. The Splitter may be a 50/50 beam splitter, the 50/50 beam splitter can be either a 1×2 coupler or a 2×2 coupler.

In addition, a realization method of the waveguide crossing section comprises at least one of a multi-mode waveguide crossing, a non-linear-shape optimized crossing, a multi-layer waveguide crossing and a multi-material-layer waveguide crossing. A waveguide direction, a waveguide length, and a waveguide angle of the waveguide crossing are not limited to what are shown in the FIG.s (for an illustration only). In addition, a type of the waveguide in the beam splitter, the waveguide crossing, the multiplexer, the demultiplexer and the function blocks comprises a channel waveguide, a ridge waveguide, a slot waveguide, a diffusion waveguide, and a photonic crystal waveguide. The light source may be an on-chip hybrid integrated light source or a heterojunction integrated light source; an integrated material comprises at least one of an III-V/silicon light source, an III-V/silicon nitride light source, an III-V/thin film lithium niobate and more; the light source may also be an external light source, being coupled into the optical chip.

In another preferred embodiment, the multiplexer or the demultiplexer comprises at least one of an rayed waveguide grating, an Echelle grating, a plurality of Mach-Zender interferometers in a cascade, a plurality of microrings in a cascade, a plurality of Mach-Zended interferometers and microrings in a cascade, a Fabry Perot interferometer; being either passive or adjustable.

In another preferred embodiment, a wavelength range of the wavelength comprises a visible optical band, an O-band, an E-band, an S-band, a C-band, an L-band, a U-band and a mid-infrared band.

An application field of the architectures of the optical transmitter, the optical receiver and the optical transceiver chip mentioned above is not limited to an optical communication and an optical interconnection only, but also including an application of a laser radar, a beam control, an optical sensing, an optical communication in a free space, an optical storage, an optical computing, and more.

While the embodiments of the present disclosure have been described in details above, it is apparent to those skilled in the art that various modifications and variations can be made to the embodiments. However, it should be understood that, such modifications and variations are within the scope and spirit of the present disclosure as set forth in the claims. Moreover, there may be other embodiments of the present invention described herein, which can be implemented or realized in various ways.

What is claimed is:

1. An optical transmitter, wherein comprising:
a plurality of light sources in a number of L×n, including n light sources with different wavelengths, and each light source with a certain wavelength has a number of L, wherein both L and n are positive integers;
m levels of beam splitting section, comprising m levels of beam splitter section and m levels of waveguide crossing section, wherein each level of the waveguide crossing section comprises a plurality of channels in a number of L×n×2^{m}, a k-th level beam splitter section comprises a plurality of beam splitters in a number of L×n×2^{k-1}, m is a positive integer, and a value range of k is from 1 to m, the m levels of beam splitting section are able to be expanded as needed; a first level beam splitter section divides an optical signal from the light sources in the number of L×n into an L×n×2¹-channel output signal; a k+1-th level beam splitter section divides an L×n×2^{k}-channel output signal coming from a k-th level beam splitter section into an L×n×2^{k+1}-channel output signal, an output signal of each channel has one output power;
a plurality of function blocks in a number of L×n×2^{m} and a plurality of multiplexers in a number of L×2^{m}, wherein a 2^{m}-channel output signal split and generated by an m-th level beam splitting section connect to m levels of waveguide crossing section and then the function blocks and the multiplexers sequentially, while each multiplexer is configured to combine n output signals with different wavelengths coming from n channels.

2. The optical transmitter according to claim 1, wherein L=1, n=N:
N light sources with different wavelengths;
m levels of beam splitting section, comprising m levels of beam splitter section and m levels of waveguide crossing section, wherein each level waveguide crossing section comprising N×2^{m} channels; a k-th level beam splitter section comprising N×2^{k-1} beam splitters, N and m being both positive integers; a value range of k being from 1 to m, the m levels of beam splitting section being able to be expanded as needed; a first level beam splitter section dividing the optical signals coming from the N light sources with different wavelengths into an N×2¹-channel output signal; a k+1-th level beam splitter section dividing an N×2^{k}-channel output signal coming from a k-th level beam splitter section into an N×2^{k+1}-channel output signal, while an output signal of each channel has one output power;
a plurality of function blocks in a number of N×2^{m} and a plurality of multiplexers in a number of 2^{m}, wherein an N×2^{m}-channel output signal split and generated by an m-th level beam splitting section, connecting to m levels of waveguide crossing section and then the function blocks and the multiplexers sequentially, while each multiplexer is configured to combine N output signals with different wavelengths coming from N channels.

3. An optical transmitter, wherein comprising:
N light sources with different wavelengths;
m levels of beam splitting section, comprising m levels of beam splitter section and at least one level waveguide crossing section, wherein each level of the waveguide crossing section comprises N×2^{m} channels, a k-th level beam splitter section comprises a plurality of beam splitters in a number of N×2^{k-1}, both N and m are positive integers greater than 1, a value range of k is from 1 to m, the m levels of beam splitting section can be expanded as needed; a first level beam splitter section divides an optical signal coming from the N light sources with different wavelengths into an N×2¹-channel output signal; a k+1-th level beam splitter section divides an N×2^{k}-channel output signal coming from a k-th level beam splitter section into an N×2^{k+1}-channel output signal, an output signal of each channel has one output power;
a plurality of function blocks in a number of N×2^{m} and a plurality of multiplexers in a number of 2^{m}, wherein, a plurality of output signals of N×2^{m} channels split and generated by an m-th level beam splitting section, connect to the function blocks and the multiplexer in a sequence, after being cross-transmitted by the at least one level waveguide crossing section, each multiplexer is configured to combine N output signals with different wavelengths coming from N channels.

4. The optical transmitter according to claim 1, wherein the beam splitter comprises at least one of a Y-shaped branch, a trident shaped branch, a multi-mode interferometer, a directional coupler, an adiabatic coupler, a bending coupler, a photonic crystal splitter, and a sub-wavelength splitter.

5. The optical transmitter according to claim 1, wherein the multiplexer comprises at least one of an arrayed waveguide grating, an Echelle grating, a cascaded Mach-Zender interferometer, a cascaded microring, a cascaded Mach-Zended interferometer and a microring, a Fabry Perot interferometer.

6. The optical transmitter according to claim 1, wherein the light source comprises at least one of an external light source, an on-chip hybrid integrated or a heterojunction integrated light source; an integrated material comprises at least one of an III-V/silicon light source, an III-V/silicon nitride light source, and an III-V/thin film lithium niobate.

7. A optical receiver, wherein comprising a plurality of demultiplexers in a number of M, a photodetector and at least one level waveguide crossing section;
the demultiplexers corresponding and connecting to a plurality of multiplexers of an optical transmitter one by one; the demultiplexer is configured to demultiplex the output signal coming from the multiplexer, before obtaining an output signal of N channels with different wavelengths;
at least one level waveguide crossing section, configured to transmit an N×M-channel output signal demultiplexed and generated by the M demultiplexers to a plurality of photodetectors in a number of N×M; the photodetectors are corresponding to the channels of the optical receiver one by one.

8. The optical receiver according to claim 7, wherein the demultiplexer comprising at least one of an arrayed waveguide grating, an Echelle grating, a plurality of Mach-Zender interferometers in a cascade, a plurality of microrings in a cascade, a plurality of Mach-Zended interferometers and microrings in a cascade, a Fabry Perot interferometer.

9. An optical transceiver chip, wherein comprising an optical receiver and the optical transmitter according to claim 1, the optical receiver comprising a demultiplexer, a photodetector and at least one level waveguide crossing section;
a number of the demultiplexer is as same as a number of the multiplexer, the demultiplexer is configured to demultiplex an output signal coming from the multiplexer, before obtaining an N-channel output signal with different wavelengths;
at least one level waveguide crossing section, a number of the channels comprised by each level waveguide crossing section is as same as a number of the channels of the optical transmitter; the at least one level waveguide crossing section is configured to transmit an N×2^{m}-channel output signal demultiplexed and generated by the 2^{m} demultiplexer to the photodetector; a channel of the photodetector corresponds to a channel of the optical receiver one by one, having a same number.

10. The optical transceiver chip according to claim 9, wherein an integrated material platform where an architecture of the optical transceiver chip is located comprising at least one of Bulk Silicon, Silicon-On-Insulator, Silicon-On-Sapphire, Silicon Dioxide, Aluminum Oxide, Indium Phosphide, Lithium Niobate, Barium Titanate and a polymer thereof.

11. The optical transceiver chip according to claim 9, wherein a type of a waveguide in the beam splitter, the waveguide crossing, the multiplexer, the demultiplexer, the function block comprising at least one of a channel waveguide, a ridge waveguide, a slot waveguide, a diffusion waveguide and a photonic crystal waveguide.

12. The optical transceiver chip according to claim 10, wherein a type of a waveguide in the beam splitter, the waveguide crossing, the multiplexer, the demultiplexer, the function block comprising a channel waveguide, a ridge waveguide, a slot waveguide, a diffusion waveguide and a photonic crystal waveguide.

13. The optical transceiver chip according to claim 9, wherein a wavelength range of the wavelengths comprising a visible optical band, an O-band, an E-band, an S-band, a C-band, an L-band, a U-band and a mid-infrared band.

14. The optical transceiver chip according to claim 10, wherein a wavelength range of the wavelengths comprising a visible optical band, an O-band, an E-band, an S-band, a C-band, an L-band, a U-band and a mid-infrared band.

15. The optical transceiver chip according to claim 9, wherein a realization method of the waveguide crossing section comprising at least one of a multi-mode waveguide crossing, a non-linear-shape optimized crossing, a multi-layer waveguide crossing and a multi-material-layer waveguide crossing.

16. The optical transceiver chip according to claim 10, wherein a realization method of the waveguide crossing section comprising at least one of a multi-mode waveguide crossing, a non-linear-shape optimized crossing, a multi-layer waveguide crossing and a multi-material-layer waveguide crossing.
